(19) United States
(12) Patent Application Publication
(10) Pub. No.: US 2015/0361777 A1
(43) Pub. Date: Dec. 17, 2015

(54) SIMULTANEOUS INJECTION OF AN ACIDIC WELL TREATMENT FLUID AND A PROPPANT INTO A SUBTERRANEAN FORMATION

(71) Applicant: CALFRAC WELL SERVICES LTD., Calgary (CA)

(72) Inventor: Youssouf Zotskine, Chestermere (CA)

(21) Appl. No.: 14/735,748

(22) PCT Filed: Dec. 13, 2013
(86) PCT No.: PCT/CA2013/001032

§ 371 Date: Jun. 10, 2015

(30) Foreign Application Priority Data
Dec. 14, 2012 (CA) 2,798,861

(51) Int. Cl. E21B 43/16; C09K 8/74; E21B 43/267; C09K 8/80

(52) U.S. Cl. CPC E21B 43/16; C09K 8/80; C09K 8/74; E21B 43/267

(57) ABSTRACT

A method of simultaneously injecting a proppant and an acidic well treatment fluid into a subterranean formation is described. The method includes pumping the acidic fluid into the formation at a high rate while simultaneously pumping a slurry containing a high concentration of proppant at a lower rate. Also described is a system for simultaneously pumping the acidic fluid and the proppant slurry into the formation.

### BACKGROUND

The present application is directed to a method of simultaneously injecting an acidic well treatment fluid and a proppant into a hydrocarbon-producing subterranean formation, and to a system for carrying out the method.

Fracturing fluids are used in the process of hydraulic fracturing to facilitate the recovery of hydrocarbon deposits within a subterranean formation. Fracturing fluid is generally pumped into the formation at high pressure so as to force the opening of cracks or fissures within the formation, allowing hydrocarbons to flow more easily from the formation. Fracturing fluids often contain large amounts of water, although methanol or hydrocarbons such as diesel, or liquified propane or methane can also be used. Often, fracturing fluids contain a suspended granular solid or proppant which remains in the formation once the fracturing fluid has been removed, where the proppant acts to prop open the channels which are formed. Fracturing fluids often also contain additives to control the viscosity and other properties of the fluids so that adequate quantities of proppant can remain suspended while the fluid is being pumped into the formation, but the proppant can be deposited within the cracks and fissures formed downhole and the remaining components can be readily removed from the fractured formation. Such additives can include gelling agents to increase viscosity, facilitating the suspension of proppant for transport into the formation, and breakers to reduce viscosity, thereby allowing proppant to be deposited in the fractures and facilitating the recovery of used fracturing fluid.

Subterranean formations can be treated with an acidic well treatment fluid during the fracturing process to increase the permeability of formations such as dolomites, limestones and other carbonate mineral-containing formations. The acid reacts with the carbonate minerals, dissolving part of the formation, and thereby creating fractures and cracks through which hydrocarbon deposits can be recovered. Commonly used acidic fluids generally contain strong acids such as hydrochloric acid at relatively high concentrations (for example, 15-28% HCl (w/w)), so that effective reaction with the carbonates in the formation can occur with a relatively low volume of acid.

Because reaction of the acid with the carbonates in the formation is rapid, acid fluids are often pumped into the formation at high rates, so that the acid fluid can penetrate further into the formation before the acid is consumed or spent. In addition, many gelling agents and viscosifiers are not compatible with such low pH conditions. Therefore, acidic well treatment fluids often have a low viscosity, especially if they are to be introduced into the formation at a high rate, for example, in conjunction with a slickwater fracturing process. Slickwater fracturing systems are used especially for stimulation of highly pressurized deeper formations, and are generally water-based fluids containing friction-reducing agents so that large volumes of fluid can be pumped rapidly through the wellbore and into the formation. Slickwater fracturing fluids therefore often have reduced viscosity compared to other fracturing fluid systems.

Production from an acid-treated formation may decline rapidly once a relatively large part of the formation has already been contacted by acid and accessible carbonates have been dissolved, as new channels are no longer being formed as readily and existing channels may have collapsed or closed under reservoir stresses. It may therefore be desired to introduce a proppant along with an acidic fluid to prevent the newly formed channels from collapsing or closing.

Because of the low viscosity of the acidic fluids, it can be difficult to incorporate large concentrations of proppant so that the proppant can remain suspended to be carried into the formation. Therefore, proppant has been introduced during acid treatment by alternating the injection of portions of acid fluid with injection of portions of a proppant-containing cross-linked fluid which has a higher viscosity so as to keep the proppant suspended. However, such an approach suffers from the disadvantage that, because cross-linked fluids have higher viscosity and experience higher friction when pumped, they must be pumped at a lower rate than the less viscous acid fluid. This reduces the rate at which the preceding acid fluid is pushed through the formation and therefore reduces the degree of penetration of the acid fluid into the formation. Furthermore, cross-linked fluids are often damaging to formations, creating filter cake and other remnants that reduce longer term conductivity of the formation. However, reducing the amount of cross-linked fluid introduced in order to avoid this damage will in turn undesirably reduce the amount of proppant deposited in the formation.

Therefore, there is a need for a method of injecting proppant into a subterranean formation along with an acidic well treatment fluid so that the proppant can be transported readily into the formation.

### SUMMARY

Accordingly, in one aspect, the present invention is directed to a method of simultaneously injecting a proppant and an acidic well treatment fluid into a subterranean formation, the method including blending a proppant with a carrier fluid to produce a proppant slurry; pumping the proppant slurry into the formation at a slurry flow rate using a slurry pumping system; and pumping the acidic well treatment fluid into the formation at an acid flow rate using an acid pumping system, such that the proppant slurry is pumped into the formation simultaneously with the acidic well treatment fluid to form a combined fluid being pumped at a combined rate.

Another aspect of the present invention is directed to a system for simultaneously injecting a proppant and an acidic well treatment fluid into a subterranean formation, the system including a slurry pumping system for pumping a proppant slurry stream into the formation at a slurry flow rate and an acid pumping system for pumping an acidic well treatment fluid stream into the formation at an acid flow rate, wherein the proppant slurry stream and the acidic well treatment fluid stream are mixed to form a combined fluid stream for injection into the formation at a combined flow rate.

Without being bound by theory, it is believed that, advantageously, simultaneous injection of proppant and an acidic well treatment fluid can, in certain embodiments, aid in preventing job failures due to the blockage of formation pores with proppant (also known as a sand-off or screen-out). If proppant carried by crosslinked-fluids or slickwater should build up at a point in the formation so as to cause a blockage in the fluid flow, it can be necessary to use time-consuming recovery procedures or coiled tubing to complete the well. However, if the proppant is injected simultaneously with an acidic well treatment fluid, the acid can react with the carbonates in the formation at a point that becomes blocked with proppant. In many cases, this can act to create a larger flowpath and eventually release the blockage without the need for further intervention, so that the acidic fluid and proppant can continue to flow in the formation.

### BRIEF DESCRIPTION OF THE DRAWINGS

Further features of the present invention will become apparent from the following written description and the accompanying figures, in which:

FIG. 1 is a diagram illustrating a wellhead pumping system for carrying out the method according to the present invention.

### DETAILED DESCRIPTION OF THE INVENTION

The present method includes blending a proppant with a carrier fluid to produce a proppant slurry; pumping the proppant slurry into the formation using a slurry pumping system; and pumping the acidic well treatment fluid into the formation using an acid pumping system, such that the proppant slurry stream mixes with the acidic well treatment fluid stream before entry into the formation, and the proppant slurry is pumped into the formation simultaneously with the acidic well treatment fluid as a combined fluid.

As will be appreciated by the person of skill in the art, the specific conditions under which the proppant slurry and acidic well treatment fluid are prepared and pumped will be selected based on the needs of the particular application, including but not limited to the desired amounts of acid and proppant to be deposited in the formation during the treatment. The particular conditions selected to carry out the present method will be influenced by factors including but not limited to the features of the formation to be treated, including the formation pressure, the geological features of the formation, and the properties of the hydrocarbon deposits therein, and the ambient environmental conditions during the treatment, including but not limited to temperature at the surface and in the formation. In light of the teaching herein, the skilled person would be able to select appropriate proppants, carrier fluids and acidic well treatment fluids, as well as flow rates and blending and pumping conditions suitable for a particular application of the present method.

The proppant used can be any suitable proppant known in the art, and can be selected by the skilled person as appropriate for the formation to be treated. Suitable proppants include but are not limited to sand, ceramic beads, resin-coated proppants and the like, and can have an appropriate size as will be appreciated by the person of skill in the art, including but not limited to a mesh size selected from 20/40 mesh, 30/50 mesh and 40/70 mesh. In at least one embodiment the proppant is sand. In at least one embodiment, the proppant, when soaked with 28% HCl, can pass a crush-resistance test at 4000 psi according to standards accepted in the art (for example, standard API RP 19C, Recommended Practice for Measurement of Proppants Used in Hydraulic Fracturing and Gravel-packing Operations, First Edition (ISO 13503-2:2006)).

The proppant is blended with a carrier fluid to produce a slurry. Suitable carrier fluids are known in the art and will have adequate viscosity to suspend the proppant at high concentrations. In at least one embodiment, the carrier fluid is an aqueous fluid or a water-based fluid, which can optionally contain one or more additives. Advantageously in at least one embodiment, when the proppant slurry combines with the acidic fluid, the acid reacts with the carrier fluid so as to reduce the viscosity of the carrier fluid and/or to consume additives in the carrier fluid. In this way, any damage to the formation which might be caused by the presence of additives in the carrier fluid can be avoided or reduced.

Suitable additives include but are not limited to gellants, crosslinkers, pH adjusters, and other additives known in the art. Suitable gellants include but are not limited to viscoelastic gellants, synthetic polymer gellants, cellulose-based gellants, xanthan-based gellants and guar-based gellants, including but not limited to guar, hydroxypropyl guar, and carboxymethylhydroxypropyl guar. Suitable crosslinkers include but are not limited to borate crosslinkers and metal crosslinkers, including but not limited to zirconium crosslinkers, antimony crosslinkers, aluminum crosslinkers, chromium crosslinkers and titanium crosslinkers. In at least one embodiment, the carrier fluid contains a zirconium-crosslinked carboxymethylhydroxypropyl guar gellant.

In at least one embodiment, the carrier fluid has a pH of from about 3 to about 6. In at least one embodiment, the carrier fluid has a pH of about 4. Advantageously, in embodiments in which the carrier fluid has a low pH, neutralization of the acidic well treatment fluid is minimized when the proppant slurry is mixed with the acidic well treatment fluid. Suitable pH adjusters include but are not limited to acids, bases and buffers, as are well known in the art. In at least one embodiment, other additives, including but not limited to the gellant and/or the crosslinker, can act to adjust the pH of the carrier fluid. In at least one embodiment, the carrier fluid contains a zirconium-crosslinked carboxymethylhydroxypropyl guar gellant and has a pH of about 4.

In at least one embodiment, the carrier fluid is DynaFlow™ fluid, DynaBrine™ fluid or CleanTech™ fluid (Calfrac Well Services). U.S. Pat. No. 6,838,418, and Canadian Patent Applications 2,322,102 and 2,357,973 describe suitable fluids. The skilled person would be readily able to select or prepare other carrier fluids which would be suitable for the formation to be treated and the hydrocarbon deposits therein.

The acidic well treatment fluid can be any suitable acidic well treatment fluid known in the art which is effective to react with the carbonate minerals in the formation. Suitable acidic well treatment fluids include but are not limited to fluids containing one or more of hydrochloric acid (HCl), hydrofluoric acid (HF) or organic acids, including but not limited to formic acid and acetic acid. The acidic well treatment fluid can be aqueous, and can contain organic components, including but not limited to xylene, and/or other additives, including but not limited to antisludge agents, emulsion control agents, friction reducing agents and corrosion inhibitors, such as are well known in the art. In at least one embodiment, the acidic well treatment fluid comprises aqueous HCl. In at least one embodiment, the aqueous HCl has a concentration of from about 15% to about 36% HCl (w/w). In at least one embodiment, the acidic fluid comprises 28% aqueous HCl (w/w), and can optionally further contain one or more organic components or additives.

In at least one embodiment, the carrier fluid is pumped to a blender at a clean flow rate, where it is mixed with the proppant to form the slurry. As will be appreciated by the person of skill in the art, the specific conditions under which the carrier fluid and proppant are mixed and pumped will be selected based on the needs of the particular application. Advantageously, the carrier fluid is pumped at the minimum practical clean flow rate so as to minimize the dilution of the acid in the acidic well treatment fluid when the proppant slurry stream and the acidic well treatment fluid stream are combined. In at least one embodiment, the carrier fluid is pumped to a blender at a clean flow rate of at least about 0.5 m³/min. In at least one embodiment, the carrier fluid is pumped to a blender at a clean flow rate of at least about 0.7 m³/min.

In at least one embodiment, the proppant is contained in the slurry at a concentration of at least about 500 kg/m′. In at least one embodiment, the proppant is contained in the slurry at a concentration of no more than about 2500 kg/m³. In at least one embodiment, the proppant is contained in the slurry at a concentration of from about 500 kg/m³ to about 1500 kg/m³. Advantageously, the proppant slurry contains a high concentration of proppant (and therefore a lower proportion of the carrier fluid), so as to minimize the dilution of the acid in the acidic well treatment fluid. The skilled person will appreciate that the clean flow rate of the carrier fluid and the rate of addition of proppant can each individually be varied during the blending and pumping of the proppant slurry in order to provide a proppant slurry stream containing proppant at an appropriate concentration and being pumped at an appropriate slurry flow rate to combine with the acidic well treatment fluid, as described below.

The proppant slurry is pumped to the formation using a slurry pumping system at a slurry flow rate suitable for mixing with the acidic well treatment fluid, as described in further detail below. In at least one embodiment, the slurry flow rate is at least about 0.5 m³/min. In at least one embodiment, the slurry flow rate is at least about 0.8 m³/min. In at least one embodiment, the slurry flow rate is from about 1.0 m³/min to about 2.0 m³/min. In at least one embodiment, the slurry flow rate is from about 1.2 m³/min to about 1.8 m³/min.

Simultaneously with pumping the proppant slurry, the acidic well treatment fluid is transported to the formation using an acid pumping system, so that the proppant slurry stream and acidic well treatment fluid stream mix and form a combined fluid which enters the wellbore. The proppant slurry stream and the acidic well treatment fluid stream are pumped separately at individual flow rates, and can be combined at any convenient point prior to entry into the formation. In at least one embodiment, the acidic well treatment fluid is pumped at a higher rate than the rate of pumping the proppant slurry. In at least one embodiment, the acidic well treatment fluid is pumped at an acid flow rate of from about 4.0 m³/min to about 12.0 m³/min. In at least one embodiment, the acidic well treatment fluid is pumped at an acid flow rate of from about 4.0 m³/min to about 10.0 m³/min. In at least one embodiment, the acidic well treatment fluid is pumped at an acid flow rate of from about 4.0 m³/min to about 8.0 m³/min. In at least one embodiment, the acidic well treatment fluid is pumped at an acid flow rate of from about 4.0 m³/min to about 6.5 m³/min. In at least one embodiment, the acidic well treatment fluid is pumped at an acid flow rate of about 6.0 m³/min.

In at least one embodiment, the combined fluid is pumped into the formation at a combined flow rate of at least about 4.5 m³/min. In at least one embodiment, the combined fluid is pumped into the formation at a combined flow rate of at least about 6.0 m³/min. In at least one embodiment, the combined fluid has a proppant concentration of at least about 40 kg/m³ when the combined fluid enters the formation. In at least one embodiment, the combined fluid has a proppant concentration of from about 100 kg/m³ to about 600 kg/m³ when the combined fluid enters the formation.

In at least one embodiment, the combined fluid has an acid concentration of at least about 15% HCl when the combined fluid enters the formation. In at least one embodiment, the combined fluid has an acid concentration of from about 20% HCl to about 27% HCl when the combined fluid enters the formation. In at least one embodiment, the acid quality of the combined fluid is at least about 82% when the combined fluid enters the formation. In at least one embodiment, the acid quality of the combined fluid is from about 82% to about 94% when the combined fluid enters the formation. The term “acid quality” as used herein is intended to indicate the relative concentration of the acid in the combined fluid relative to the concentration of the acid in the acidic well treatment fluid, and is calculated by dividing the concentration of the acid in the combined fluid by the concentration of the acid in the acidic well treatment fluid and multiplying the result of the division by 100%.

It will be clear to the person of skill in the art that the specific concentrations or amounts of acid and proppant injected into the well can be controlled by varying at least the flow rates and compositions of the acidic well treatment fluid and the proppant slurry. For example, the proppant concentration and/or the acid quality in the combined fluid can be changed by changing the proppant concentration in the proppant slurry and/or by changing one or both of the proppant slurry flow rate and the acid flow rate.

Furthermore, it may be desired to change the composition of the combined fluid entering the formation over time as the well treatment progresses. For example, it may be desired to increase the proppant concentration and/or the acid quality in the combined fluid over time, such that increasing quantities of proppant are placed in the formation as the acid fluid reacts with the carbonate minerals. In at least one embodiment of such a case, the rate of addition of proppant to the proppant slurry can be increased over time, for example, such that the proppant concentration in the proppant slurry, and thus in the combined fluid, increases over the course of the well treatment. In this way, increasing amounts of proppant will be placed as the treatment progresses. Furthermore, the acid quality of the combined fluid can be increased as the treatment progresses by decreasing the relative proportion of the carrier fluid in the combined stream over time. Thus, the present method can be adapted to the particular needs of a specific application, as will be apparent to one skilled in the art.

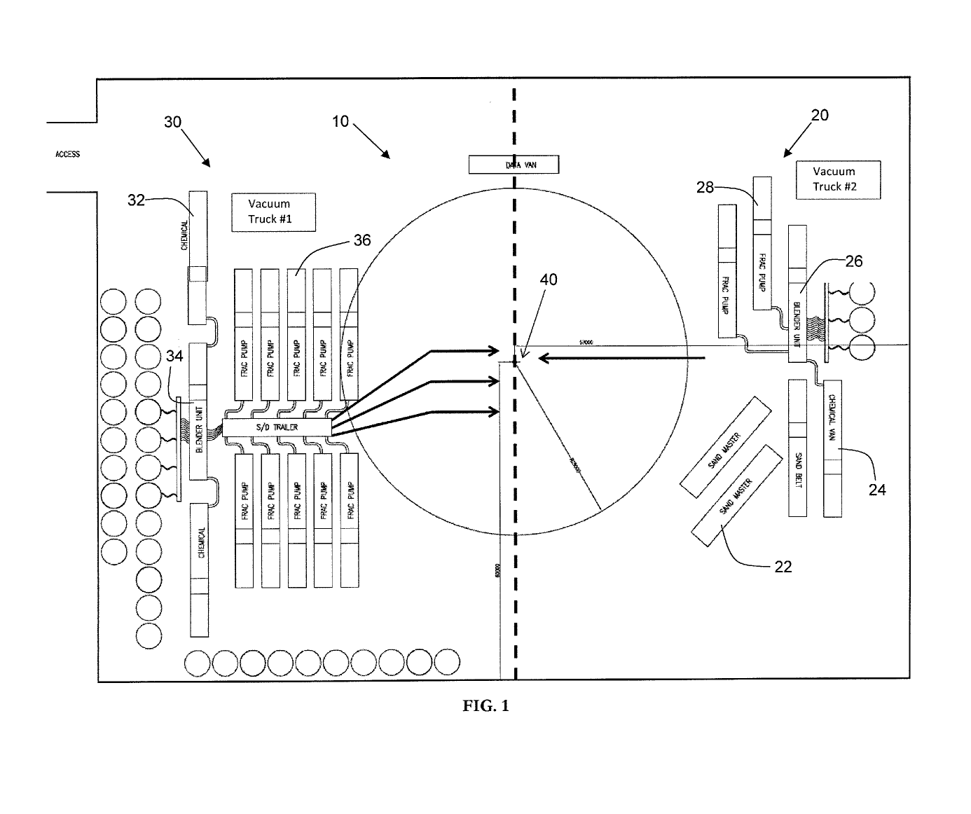

A system for carrying out the method described herein is seen in FIG. 1. System 10 includes slurry pumping system 20, including proppant source 22 and carrier fluid source 24. Sand from proppant source 22 and carrier fluid from fluid source 24 are blended in blender 26 and the resulting proppant slurry is pumped to wellhead 40 by one or more pumps 28. System 10 also includes acid pumping system 30, including acidic well treatment fluid source 32 which provides acidic well treatment fluid to blender 34, where the acidic well treatment fluid can be mixed with one or more additives. One or more pumps 36 then pump the acidic well treatment fluid to the wellhead 40. The streams of proppant slurry and acidic well treatment fluid are combined to form the combined fluid before entering the wellbore.

### EXAMPLES

Other features of the present invention will become apparent from the following non-limiting examples which illustrate, by way of example, the principles of the invention.

### Example 1

Carrier fluid (CleanTech™ or DynaFlow-1™) is pumped into a blender and blended with sand. The resulting slurry stream is combined with a separately pumped stream of 28% HCl and the combined fluid stream is pumped into a wellhead in stages. Specific representative conditions for treatment of an individual zone of a formation in a ball-actuated, packer-isolated completion method are provided in Tables 1 and 2.

TABLE 1

| | | | | Amount added | | | | | | |
|---|---|---|---|---|---|---|---|---|---|---|
| | Pumping rate | | | per stage | | | Slurry | Acid | Acid | Proppant |
| | (m³/min) | | | | | 28% | conc. at | Quality at | conc. at | conc. at |
| | | | 28% | Sand | Carrier | HCl | blender | wellhead | wellhead | wellhead |
| Stage | Carrier | Slurry | HCl | (kg) | (m³) | (m³) | (kg/m³) | (%) | (%) | (kg/m³) |
| 1 | 0.73 | 0.9 | 9.0 | 600 | 1.0 | 12.3 | 600 | 92.5 | 26 | 45 |
| 2 | 0.72 | 1.1 | 9.0 | 1400 | 1.0 | 12.5 | 1400 | 92.6 | 26 | 104 |
| 3 | 0.74 | 1.3 | 9.0 | 4000 | 2.0 | 24.3 | 2000 | 92.4 | 26 | 152 |
| 4 | 0.71 | 1.3 | 9.0 | 4000 | 1.8 | 23.1 | 2200 | 92.7 | 26 | 161 |

TABLE 2

| | | | | Amount added | | | | | | |
|---|---|---|---|---|---|---|---|---|---|---|
| | Pumping rate | | | per stage | | | Slurry | Acid | Acid | Proppant |
| | (m³/min) | | | | | 28% | conc. at | Quality at | Conc. at | conc. at |
| | | | 28% | Sand | Carrier | HCl | blender | wellhead | wellhead | wellhead |
| Stage | Carrier | Slurry | HCl | (kg) | (m³) | (m³) | (kg/m³) | (%) | (%) | (kg/m³) |
| 1 | 1.26 | 1.4 | 6.0 | 427 | 1.5 | 7.1 | 285 | 82.6 | 23.1 | 50 |
| 2 | 1.13 | 1.4 | 6.0 | 945 | 1.5 | 8.0 | 630 | 84.1 | 23.5 | 100 |
| 3 | 1.00 | 1.4 | 6.0 | 1575 | 1.5 | 9.0 | 1050 | 85.7 | 24.0 | 150 |
| 4 | 0.88 | 1.4 | 6.0 | 2308 | 1.5 | 10.1 | 1565 | 87.2 | 24.4 | 200 |
| 5 | 0.76 | 1.4 | 6.0 | 3244 | 1.5 | 11.6 | 2200 | 88.7 | 24.8 | 250 |

As can be seen from Tables 1 and 2, when a proppant slurry is pumped simultaneously with 28% HCl, the acid quality of the mixed stream in the wellbore is maintained at a high level of from about 82% to about 93%. Thus, the ability of the acidic well treatment fluid to etch the formation and create new fractures is preserved, while proppant is also introduced into the formation to prevent the newly formed fractures from closing.

### Example 2

A comparison of the present method to a traditional acid stimulation was carried out at a two-well pad. The two wells (A and B) are 400 m apart and have similar reservoir characteristics, lateral length, drilling orientation, and number of zones (30 zones each). The toe ports of each well, which are furthest from the surface, are opened using a hydraulic shift, and the reservoir pressure is recorded. Completion of the wells is carried out using a ball-actuated, packer isolated completion method.

Well A is stimulated with 70 m³ of 28% HCl per zone at high flow rates of 8-10 m³/min in the absence of proppant, and put on production. Four months after stimulation of Well A, the reservoir pressure of Well B is measured at its toe, and was found to have dropped from its reservoir pressure measured prior to stimulation of Well A. Well B is then stimulated using the present method with 40 m³ of 28% HCl per zone and 10,000-12,000 kg of sand (20/40 mesh, including 1000 kg of 30/50 mesh sand) proppant per zone, carried in DynaFlow™-1 carrier fluid. The combined flow rate of acid treatment fluid and proppant slurry is 8.0 m³/min, the maximum concentration of proppant in the combined fluid is 400 kg/m³, and the downhole acid concentration is 23-26% HCl (82%-93% acid quality). Well B is then put on production. The initial production of Well B was measured and found to be over three times the initial production of Well A, despite the drop in reservoir pressure in Well B subsequent to the stimulation of Well A. Measurement of the steady flow of Well B a few months later showed that the production of Well B remained more than double the production of Well A.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

1. A method of simultaneously injecting a proppant and an acidic well treatment fluid into a subterranean formation, the method comprising:
blending the proppant with a carrier fluid to produce a proppant slurry;
pumping the proppant slurry into the formation at a slurry flow rate using a slurry pumping system; and
pumping the acidic well treatment fluid into the formation at an acid flow rate using an acid pumping system, such that the proppant slurry is pumped into the formation simultaneously with the acidic well treatment fluid to form a combined fluid being pumped at a combined flow rate.

2. The method according to claim 1 wherein the acid flow rate is greater than the slurry flow rate.

3. The method according to claim 1 wherein the slurry flow rate is at least about 0.5 m³/min.

4. The method according to claim 1 wherein the acid flow rate is from about 4.0 m³/min to about 12.0 m³/min.

5. The method according to claim 1 wherein the combined flow rate is at least about 4.5 m³/min.

6. The method according to claim 1 wherein the carrier fluid is an aqueous fluid comprising at least one gellant and having a pH of from about 3 to about 6.

7. The method according to claim 1 wherein the proppant is sand.

8. The method according to claim 1 wherein the concentration of proppant in the proppant slurry is from about 500 kg/m³ to about 2500 kg/m³.

9. The method according to claim 1 wherein the combined fluid comprises at least about 15% hydrochloric acid by weight.

10. The method according to claim 1 wherein the acid quality in the combined fluid is at least about 82%.

11. A system for simultaneously injecting a proppant and an acidic well treatment fluid into a subterranean formation, the system comprising:
a slurry pumping system for pumping a proppant slurry stream at a slurry flow rate, wherein the proppant slurry stream comprises a carrier fluid and the proppant; and
an acid pumping system for pumping an acidic well treatment fluid stream at an acid flow rate;
wherein the proppant slurry stream is mixed with the acidic well treatment fluid stream to form a combined fluid stream for injection into the formation at a combined flow rate.

12. The system according to claim 11 wherein the acid flow rate is greater than the slurry flow rate.

13. The system according to claim 11 wherein the slurry flow rate is at least about 0.5 m³/min.

14. The system according to claim 11 wherein the acid flow rate is from about 4.0 m³/min to about 12.0 m³/min.

15. The system according to claim 11 wherein the combined flow rate is at least about 4.5 m³/min.

16. The system according to claim 11 wherein the carrier fluid is an aqueous fluid comprising at least one gellant and having a pH of from about 3 to about 6.

17. The system according to claim 11 wherein the proppant is sand.

18. The system according to claim 11 wherein the concentration of proppant in the proppant slurry is from about 500 kg/m³ to about 2500 kg/m³.

19. The system according to claim 11 wherein the combined fluid comprises at least about 15% hydrochloric acid by weight.

20. The system according to claim 11 wherein the acid quality in the combined fluid is at least about 82%.
